(19) United States
(12) Patent Application Publication
(10) Pub. No.: US 2013/0342026 A1
(43) Pub. Date: Dec. 26, 2013

(54) POWER-RECEIVING DEVICE AND NON-CONTACT POWER TRANSMISSION SYSTEM USING SAME

(71) Applicants: Koichi Mishina, Sendai-shi (JP); Koji Sato, Sendai-shi (JP)

(72) Inventors: Koichi Mishina, Sendai-shi (JP); Koji Sato, Sendai-shi (JP)

(73) Assignee: NEC TOKIN CORPORATION, Sendai-shi, Miyagi (JP)

(21) Appl. No.: 14/004,123

(22) PCT Filed: Mar. 9, 2012
(86) PCT No.: PCT/JP2012/056121

§ 371 Date: Sep. 9, 2013

(30) Foreign Application Priority Data
Mar. 10, 2011 (JP) 2011053378

(51) Int. Cl. H01F 38/14

(52) U.S. Cl. CPC H01F 38/14
USPC 307/104

(57) ABSTRACT

A power-receiving device in a non-contact power transmission system includes a power-receiving antenna circuit for receiving power transmitted from a power-transmitting device, a rectification circuit for rectifying power received by the power-receiving antenna circuit, a frequency-changing circuit for changing a received power frequency of the power-receiving antenna circuit, and a drive circuit for driving the frequency-changing circuit. The power-receiving antenna circuit includes two terminals, La and Lb. The frequency-changing circuit includes a circuit configuration symmetrical about the circuit center (center tap (CT)) thereof, and is connected between the terminals La and Lb. The rectification circuit is a single-phase bridge rectification circuit. A ground terminal of the rectification circuit is connected to the circuit center (center tap (CT)) of the frequency-changing circuit.

### TECHNICAL FIELD

This invention relates to a non-contact power transmission system which transmits power in non-contact between a power-transmitting device such as a recharger and a power-receiving device mounted in a mobile electronic device. In particular, this invention relates to the power-receiving device.

### BACKGROUND ART

For example, when power is transmitted in non-contact from a single power-transmitting device to a plurality of power-receiving devices, each power-receiving device might need specific power different from others. Also, due to change of a condition of a load in a power-receiving device, an amount of power needed for the power-receiving device might change. In those cases, a power-receiving device is required to perform power control. For example, Patent Document 1 discloses a non-contact power transmission system which includes a power-receiving device performing power control. The power-receiving device of Patent Document 1 includes a half-wave rectification circuit as a rectification circuit.

### PRIOR ART DOCUMENTS

### Patent Document(s)

Patent Document 1: JP2005-278400A, Embodiments 6 to 9

### SUMMARY OF INVENTION

### Technical Problem

However, the power-receiving device of Patent Document 1 has a problem that power efficiency is low.

It is an object of the present invention to provide a power-receiving device capable of increasing power efficiency.

### SOLUTION TO PROBLEM

The present invention provides, as a first power-receiving device, a power-receiving device comprising: a power-receiving antenna circuit for receiving power transmitted from a power-transmitting device in a non-contact power transmission system; a resonant capacitor; a rectification circuit for rectifying the power received at the power-receiving antenna circuit; a frequency-changing circuit for changing a power-receiving frequency of the power-receiving antenna circuit; and a drive circuit for driving the frequency-changing circuit, wherein:

the power-receiving antenna circuit has two terminals;

the resonant capacitor is coupled between the two terminals of the power-receiving antenna circuit;

the rectification circuit is a single-phase bridge rectification circuit and includes input terminals, a ground terminal and a rectification output terminal, the input terminals being connected to the two terminals of the power-receiving antenna circuit, respectively, the rectification output terminal being for outputting a rectified direct-current voltage;

the frequency-changing circuit includes a first impedance, a second impedance and a semiconductor switch circuit, one end of the first impedance being connected to one of the terminals of the power-receiving antenna circuit, one end of the second impedance being connected to a remaining one of the terminals of the power-receiving antenna circuit, the semiconductor switch circuit being connected between another end of the first impedance and another end of the second impedance;

the semiconductor switch circuit has a circuit structure that has a center tap as a circuit center and is symmetrical with respect to the center tap;

the center tap is coupled to the ground terminal of the rectification circuit; and

the drive circuit is coupled to the rectification output terminal and turns the semiconductor switch circuit on in response to the direct-current voltage.

The present invention provides, as a second power-receiving device, the first power-receiving device, wherein the first impedance and the second impedance are capacitors which have capacitances equal to one another.

The present invention provides, as a third power-receiving device, the first or the second power-receiving device, wherein the drive circuit causes the semiconductor switch circuit to turn on when the direct-current voltage output from the rectification output terminal reaches a predetermined value.

The present invention provides, as a fourth power-receiving device, the third power-receiving device, wherein:

the drive circuit comprises a Zener diode for sensing variation of the direct-current voltage; and the predetermined value is a breakdown voltage of the Zener diode.

The present invention provides, as a fifth power-receiving device, the fourth power-receiving device, wherein an anode of the Zener diode is coupled to the semiconductor switch circuit.

The present invention provides, as a sixth power-receiving device, the fourth power-receiving device, wherein the drive circuit further comprises a drive voltage generation circuit which is coupled between an anode of the Zener diode and the semiconductor switch circuit and, when the Zener diode is broken down, generates a drive voltage for driving the semiconductor switch circuit.

The present invention provides, as a seventh power-receiving device, the sixth power-receiving device, wherein the drive voltage generation circuit exhibits hysteresis on a relation between an input and an output thereof.

The present invention provides, as an eighth power-receiving device, the sixth power-receiving device, wherein the drive voltage generation circuit supplies the semiconductor switch circuit with pulses as the drive voltage when the Zener diode is broken down.

The present invention provides, as a ninth power-receiving device, the third power-receiving device, wherein the drive circuit comprises a reference voltage generation circuit for generating a reference voltage and a hysteresis comparator for driving the semiconductor switch circuit in response to the rectified direct-current voltage.

The present invention provides, as a tenth power-receiving device, one of the first to the eighth power-receiving devices, wherein:

the semiconductor switch circuit includes at least two Nch FETs;

gates of the two FETs are electrically connected with each other;

sources of the two FETs are connected with each other; and

the center tap is derived from a connection point between the sources.

The present invention provides, as an eleventh power-receiving device, one of the first to the eighth power-receiving devices, wherein:

the semiconductor switch circuit includes at least two npn-type bipolar transistors;

bases of the two bipolar transistors are electrically connected with each other;

emitters of the two bipolar transistors are connected with each other; and

the center tap is derived from a connection point between the emitters.

The present invention provides, as a first non-contact power transmission system, a non-contact power transmission system which comprises: one of the first to the eleventh power-receiving devices; and a power-transmitting device.

### ADVANTAGEOUS EFFECTS OF INVENTION

According to the present invention, a single-phase bridge rectification circuit is used as a rectification circuit. Therefore, received power efficiency can be made high.

The frequency-changing circuit is constructed to has a circuit structure which is symmetrical with respect to its circuit center. To the power-receiving antenna circuit, the first impedance and the second impedance both used for changing a power-receiving frequency are coupled. Thus, in the case of frequency adjustment, well-balanced adjustment can be carried out for the positive waves (positive components) and the negative waves (negative components). Note that the power-receiving frequency is a resonant frequency of a resonant circuit which includes the power-receiving antenna circuit for receiving power.

The circuit center (center tap) of the semiconductor switch circuit of the frequency-changing circuit is coupled to the ground terminal of the rectification circuit. Namely, a voltage of the center tap is set equal to the ground level in a voltage rectified by the rectification circuit. Therefore, it is unnecessary to provide another power system specialized for driving the semiconductor switch circuit.

The drive circuit is provided with the Zener diode, which is used as an element for sensing variation of the rectified direct-current voltage. Thus, in comparison with a simple potential division of the rectified direct-current voltage, it is easy to control operations of the frequency-changing circuit.

### BRIEF DESCRIPTION OF DRAWINGS

FIG. 1 is a diagram schematically showing a circuit structure of a non-contact power transmission system in accordance with a first embodiment of the present invention.

FIG. 2 is a graph showing a relation between a transmission voltage and a reception voltage in the non-contact power transmission system of FIG. 1.

FIG. 3 is a diagram schematically showing a circuit structure of a non-contact power transmission system in accordance with a second embodiment of the present invention.

FIG. 4 is a diagram schematically showing a circuit structure of a non-contact power transmission system in accordance with a third embodiment of the present invention.

FIG. 5 is a diagram schematically showing a circuit structure of a non-contact power transmission system in accordance with a fourth embodiment of the present invention.

FIG. 6 is a diagram showing a modification of the frequency-changing circuit included in the power-receiving device.

### DESCRIPTION OF EMBODIMENTS

### First Embodiment

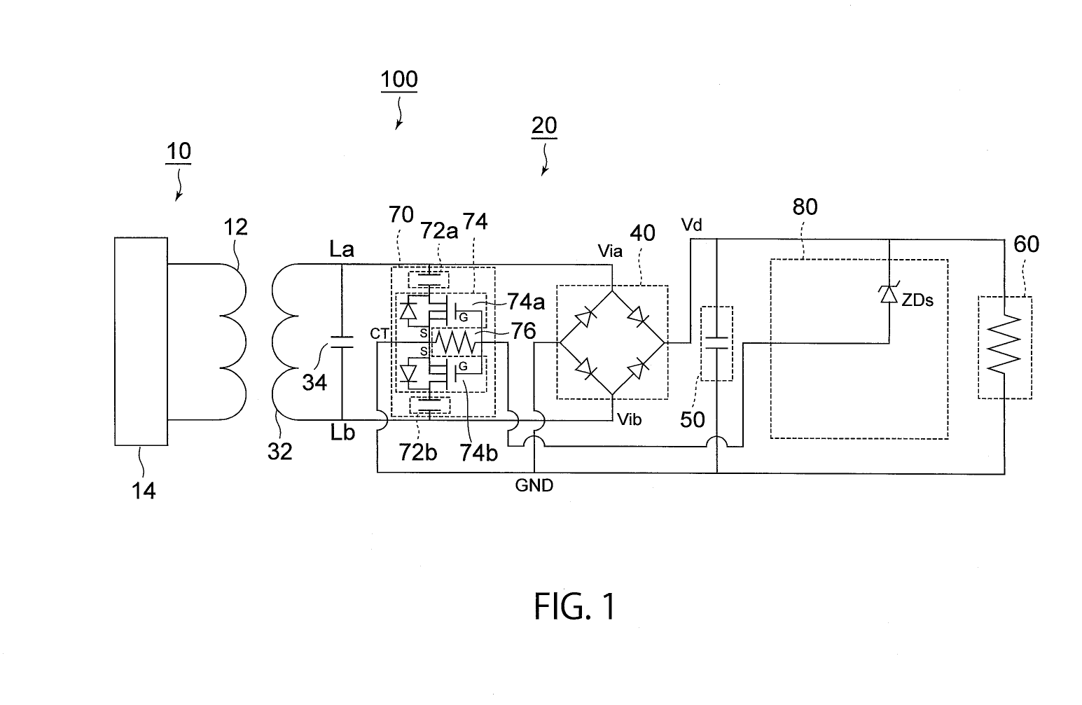

With reference to FIG. 1, a non-contact power transmission system 100 according to a first embodiment of the present invention comprises a power-transmitting device 10 such as a non-contact recharger and a power-receiving device 20 for receiving power transmitted from the power-transmitting device 10.

The power-transmitting device 10 comprises a power-transmitting antenna circuit 12 for transmitting power and a control section 14 coupled to the power-transmitting antenna circuit 12 to generate an alternating magnetic field.

The power-receiving device 20 comprises a power-receiving antenna circuit 32, a capacitor 34, a rectification circuit 40, a smoothing circuit 50, a load 60, a frequency-changing circuit 70 and a drive circuit 80, wherein the power-receiving antenna circuit 32 receives the power transmitted from the power-transmitting device 10, the capacitor 34 is coupled between two terminals La, Lb of the power-receiving antenna circuit 32, the rectification circuit 40 rectifies the power received by the power-receiving antenna circuit 32, the smoothing circuit 50 smoothes the power rectified by the rectification circuit 40, the load 60 is supplied with the smoothed power, the frequency-changing circuit 70 changes a power-receiving frequency of the power-receiving antenna circuit 32, and the drive circuit 80 drives the frequency-changing circuit 70. With this structure, the power-receiving frequency of the power-receiving antenna circuit 32 is substantially determined by a resonant frequency of a resonant circuit that comprises the power-receiving antenna circuit 32, the capacitor 34 and the frequency-changing circuit 70. In the present embodiment, an initial value of the power-receiving frequency is set to a frequency which cause the power-receiving antenna circuit 32 to receive, at the maximum, the power transmitted from the power-transmitting antenna circuit 12.

The rectification circuit 40 according to the present embodiment is a single-phase bridge rectification circuit composed of four diodes. Two input terminals Via, Vib of the rectification circuit 40 are connected to two terminals La, Lb of the power-receiving antenna circuit 32, respectively. The rectification circuit 40 further includes a rectification output terminal Vd for outputting a rectified direct-current voltage and a ground terminal GND for outputting a ground voltage for the rectified direct-current voltage. The smoothing circuit 50 according to the present embodiment is a capacitor. Opposite ends of the smoothing circuit 50 are connected to the rectification output terminal Vd and the ground terminal GND, respectively.

The load 60 is a simulation of a system load of DC-DC converter, or the like, of an electronic device on which the power-receiving device 20 is mounted. The load 60 varies lighter or heavier due to its situation. If power reception efficiency is set highest , or if an initial power-receiving frequency is identical with that of the power-transmitting device 10, when the load 60 is heavier, the reception voltage becomes too high when the load 60 is lighter. In order that the reception voltage supplied to the load 60 is decreased in that case, the present embodiment changes the status of the frequency-changing circuit 70 so that the resonant frequency (power-receiving frequency) of the resonant circuit including the power-receiving antenna circuit 32 is shifted from its initial value. Thus, the reception voltage is prevented from becoming higher than necessary.

In detail, the frequency-changing circuit 70 according to the present embodiment comprises a first impedance 72a, a second impedance 72b, a semiconductor switch circuit 74 and a resistor 76. The first impedance 72a and the second impedance 72b are capacitors, respectively, and have capacitances equal to one another. One end of the first impedance 72a is coupled to the terminal La of the power-receiving antenna circuit 32. One end of the second impedance 72b is coupled to the terminal Lb of the power-receiving antenna circuit 32. The semiconductor switch circuit 74 is coupled between the other end of the first impedance 72a and the other end of the second impedance 72b. The semiconductor switch circuit 74 has a circuit structure that has a center tap CT as its circuit center and is symmetrical with respect to the center tap CT. As understood from the above, the frequency-changing circuit 70 also has a circuit structure that is symmetrical with respect to its circuit center, which is the center tap CT of the semiconductor switch circuit 74 in this embodiment. The resistor 76 is for generating a voltage that is used for turning the semiconductor switch circuit 74 on. In addition, the center tap CT according to the present embodiment is coupled to the ground terminal GND of the rectification circuit 40.

The illustrated semiconductor switch circuit 74 has two Nch-FET 74a, 74b. The FETs 74a, 74b have body diodes or parasitic diodes, respectively. The gates G of the FETs 74a, 74b are electrically coupled with each other. The sources S of the FETs 74a, 74b are electrically coupled with each other, too. The above-mentioned center tap CT is derived from the connection point between the source S of the FET 74a and the source S of the FET 74b. The resistor 76 is coupled between the sources S and the gates G of the FETs 74a, 74b.

The frequency-changing circuit 70 with the above-mentioned structure is can be represented as equivalent circuits different from each other, which correspond to the case of the FETs 74a, 74b turning on and the case of the FETs 74a, 74b turning off. In detail, when the FETs 74a, 74b turn on, the equivalent circuit of the frequency-changing circuit 70 has a circuit in which small on-state resistances of the FETs 74a, 74b and the first impedance 72a and the second impedance 72b are connected in series. On the other hand, when the FETs 74a, 74b turn off, the equivalent circuit of the frequency-changing circuit 70 has another circuit in which the parasitic capacitances of the FETs 74a, 74b and the first impedance 72a and the second impedance 72b are connected in series. In other words, impedances connected between the terminals La, Lb of the power-receiving antenna circuit 32 vary in correspondence with whether the FETs 74a, 74b turn on or off, so that the power-receiving frequency varies. As described above, the power reception efficiency according to the present embodiment is set highest when the FETs 74a, 74b turn off. Therefore, when the FETs 74a, 74b turn on, the power reception efficiency can be intentionally lowered.

The drive circuit 80 decides a condition that the drive circuit 80 drives the semiconductor switch circuit 74 of the frequency-changing circuit 70. The drive circuit 80 senses variation of the direct-current voltage after rectified and switches the semiconductor switch circuit 74 to turn on/off.

As understood from the above, the drive circuit 80 is coupled between the rectification output terminal Vd of the rectification circuit 40 and the semiconductor switch circuit 74. Specifically, the drive circuit 80 according to the present embodiment is formed only of a Zener diode ZDs for sensing variation of the rectified direct-current voltage. The cathode of the Zener diode ZDs is connected to the rectification output terminal Vd of the rectification circuit 40. The anode of the Zener diode ZDs is connected to the gates G of the FETs 74a, 74b of the semiconductor switch circuit 74.

When the rectified direct-current voltage reaches or exceeds the breakdown voltage of the Zener diode ZDs, or when the Zener diode ZDs is broken down, a voltage is supplied from the drive circuit 80 to the frequency-changing circuit 70 so that a voltage occurs between the opposite ends of the resistor 76. In this embodiment, because the voltage occurring between the opposite ends of the resistor 76 is set equal to or greater than the gate-source voltage Vgs of each of the FETs 74a, 74b, the FETs 74a, 74b turn on. In this embodiment, the breakdown voltage of the Zener diode ZDs is set on a reception voltage to be suppressed. Therefore, if a reception voltage reaches a voltage to be suppressed, the Zener diode ZDs is broken down so that the frequency-changing circuit 70 shifts its power-receiving frequency from the initial value to lower the reception voltage.

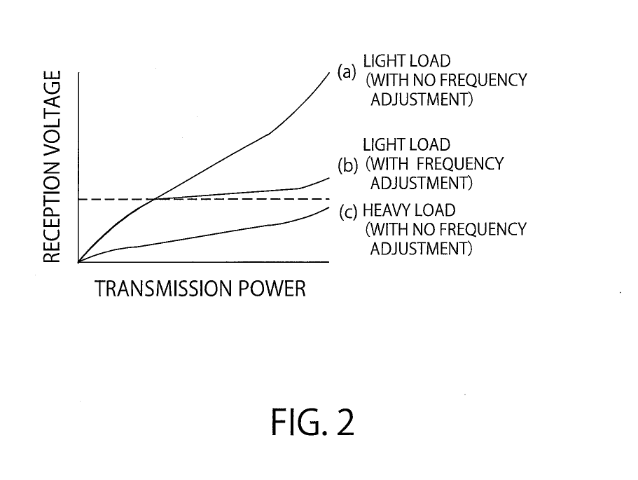

As shown in FIG. 2, if the load is heavy, a reception voltage is low even when a transmission power becomes high (FIG. 2(c)). If the load is light, a reception voltage becomes high unless the power-receiving frequency is adjusted (FIG. 2(a)). As the present embodiment, the power-receiving frequency is shifted from its initial value upon the light load so that a reception voltage can be suppressed and prevented from exceeding a voltage required (FIG. 2(b)).

### Second Embodiment

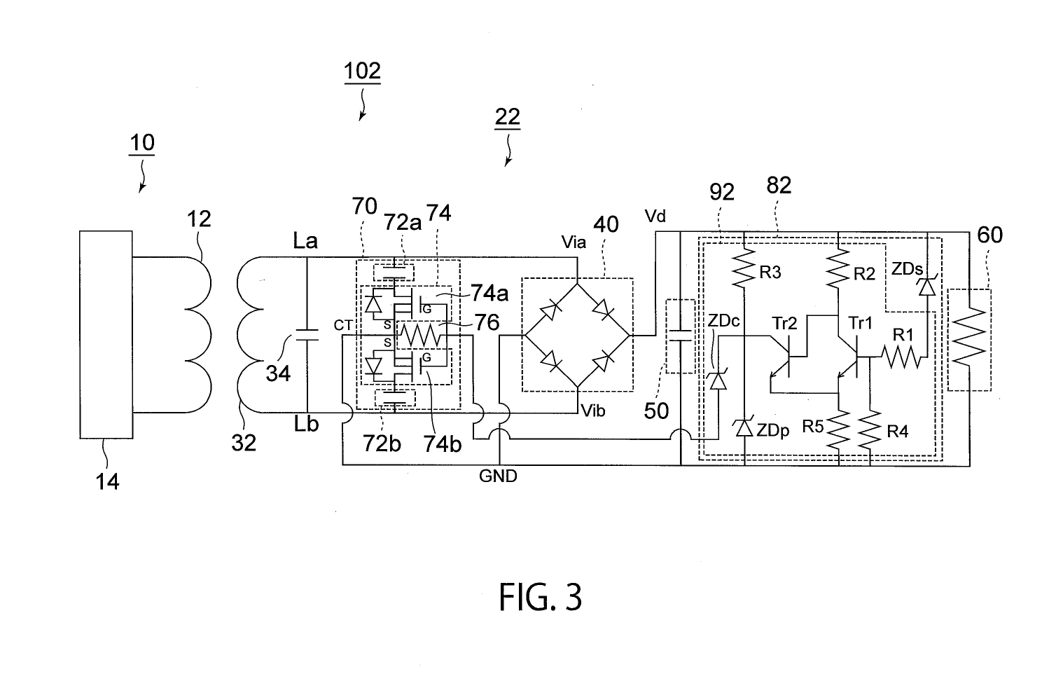

With reference to FIG. 3, a non-contact power transmission system 102 according to a second embodiment of the present invention has a structure similar to the non-contact power transmission system 100 according the above-described first embodiment (see FIG. 1), except for a structure of a drive circuit 82 of a power-receiving device 22. Common components between FIG. 1 and FIG. 3 are depicted with reference numerals same as each other; explanation thereabout will be omitted. Thus, only the drive circuit 82 and distinct operations based thereon will be explained hereinafter.

As shown in FIG. 3, the drive circuit 82 comprises a Zener diode ZDs for sensing variation of the rectified direct-current voltage and a drive voltage generation circuit 92 which generates a drive voltage for driving the semiconductor switch circuit 74 when the Zener diode ZDs is broken down, wherein the drive voltage is a voltage that causes the FET 74a, 74b to turn on. The cathode of the Zener diode ZDs is supplied with the rectified direct-current voltage, similar to the first embodiment. Namely, the cathode of the Zener diode ZDs is connected to the rectification output terminal Vd. On the other hand, the anode of the Zener diode ZDs is different from the first embodiment and is not connected to the frequency-changing circuit 70. In this embodiment, the drive voltage generation circuit 92 is provided between the anode of the Zener diode ZDs and the frequency-changing circuit 70.

The drive voltage generation circuit 92 has a hysteresis on a relation between its input and its output. In detail, the drive voltage generation circuit 92 comprises two transistors Tr1, Tr2, five resistors R1-R5, and two Zener diodes ZDc, ZDp. The resistor R1 is connected between the base of the transistor Tr1 and the anode of the Zener diode ZDs. The resistor R2 is connected between the rectification output terminal Vd and the collector of the transistor Tr1. The resistor R3 is connected between the rectification output terminal Vd and the collector of the transistor Tr2. Thus, the rectified direct-current voltage is also used as a power for the transistors Tr1, Tr2. The resistor R4 is connected between the base of the transistor Tr1 and the ground. The resistor R5 is connected between the emitter of the transistor Tr1 and the ground. The base of the transistor Tr2 is connected to the collector of the transistor Tr1. The emitter of the transistor Tr2 is connected to the emitter of the transistor Tr1. The cathode of the Zener diode ZDp is connected to the collector of the transistor Tr2. The anode of the Zener diode ZDp is connected to the ground. The cathode of the Zener diode ZDc is connected to the collector of the transistor Tr2. The anode of the Zener diode ZDc is connected to the semiconductor switch circuit 74.

When the Zener diode ZDs is broken down, a voltage occurs at the base of the transistor Tr1. The resistor R1 regulates the base current of the transistor Tr1 and adjusts the input voltage of the base of the transistor Tr1 in cooperation with the resistor R4. When the base of the transistor Tr1 is supplied with a voltage equal to or more than a sum of the voltage level V_{E} and the base-emitter voltage V_{BE}, i.e., V_{E}+V_{BE}, the transistor Tr1 turns on, wherein the voltage level V_{E} is of the emitter of the transistor Tr1 with respect to the ground, and the base-emitter voltage V_{BE} is between the base and the emitter of the transistor Tr1 and is required to switch the transistor Tr1. The resistor R1 and the resistor R4 are selected so as to supply a voltage for causing the transistor Tr1 to turn on when the Zener diode ZDs is broken down.

In this embodiment, although the transistor Tr2 is under the on-state when the transistor Tr1 is under the off-state, the transistor Tr2 turns off when the transistor Tr1 turns on. The resistor R2 is set larger than the resistor R3, and the resistor R3 is set larger than the resistor R5. The resistor R5 is set a value very smaller than the resistor R2. Specifically, when the transistor Tr1 is under the on-state while the transistor Tr2 is under the off-state, the emitter voltage level V_{E} of the transistor Tr1 comes close to the ground level because the emitter voltage V_{E} becomes a voltage occurring between the opposite ends of the resistor R5 on the basis of the relation between the resistor R2 and the resistor R5. On the other hand, when the transistor Tr1 is under the off-state while the transistor Tr2 is under the on-state, the emitter voltage level V_{E} is determined by a current flowing into the resistor R5 from the transistor Tr2. Thus, the emitter voltage level V_{E} varies depending on whether the transistor Tr1 is under the on-state or the off-state. herefore, the transistor Tr1 also has different threshold level depending upon two transitions, in one of which the transistor Tr1 turns on from the off-state (i.e., the transistor Tr2 turns off from the on-state); in the other transition, the transistor Tr1 turns off from the on-state (i.e., the transistor Tr2 turns on from the off-state).

When the transistor Tr2 is under the on-state, the semiconductor switch circuit 74 of the frequency-changing circuit 70 is supplied, through the Zener diode ZDc, with a voltage divided by the resistor R3 and the resistor R5. In this embodiment, the divided voltage is set lower than a voltage required to cause the semiconductor switch circuit 74 to turn on. Therefore, when the transistor Tr2 is under the on-state, the power-receiving frequency is kept at its initial value.

When the Zener diode ZDs is broken down so that the transistor Tr2 turns off, a voltage determined by the Zener diode ZDp is supplied through the Zener diode ZDc. Namely, a voltage, which is supplied to the frequency-changing circuit 70 when the Zener diode ZDs is broken down, is hardly changed in this embodiment. The voltage determined by the Zener diode ZDp is set a value that is able to surely change the semiconductor switch circuit 74 into the on-state, in this embodiment. Therefore, when the voltage determined by the Zener diode ZDp is supplied to the frequency-changing circuit 70, the semiconductor switch circuit 74 turns on so that the power-receiving frequency is adjusted to lower the reception voltage.

As described above, since the voltage occurring between the opposite ends of the resistor R5 is very small under the off-state of the transistor Tr2, the threshold level of the transistor Tr1 is practically equal to or close to the base-emitter voltage V_{BE} of the transistor Tr1, which is required to switch the transistor Tr1. Therefore, as a result of the transistor Tr2 turning off and the reception voltage being lowered, the transistor Tr1 keeps its on-state if the base voltage level of the transistor Tr1 is greater than the base-emitter voltage V_{BE}, while the transistor Tr1 turns off but the transistor Tr2 turns on if the base voltage level becomes smaller than the base-emitter voltage V_{BE}. Thus, a hysteresis exhibits on a relation between the input and the output of the drive voltage generation circuit 92, wherein the input is a voltage supplied to the base of the transistor Tr1, and the output is the collector voltage level of the transistor Tr2, or the voltage level of the anode of the Zener diode ZDc. Therefore, the power-receiving frequency can be returned to its initial value after the adjustment of the power-reception frequency surely lowers the reception voltage, without reacting upon a temporal voltage dropdown caused by the Zener diode ZDs being broken down.

As described above, since the drive voltage generation circuit 92 has a hysteresis on the relation between its input and its output in this embodiment, a substantially-constant voltage is supplied to the semiconductor switch circuit 74 of the frequency-changing circuit 70 upon the breakdown of the Zener diode ZDs until the adjustment of the power-receiving frequency surely affects. Therefore, the present embodiment can surely drive the semiconductor switch circuit 74.

If a value of the rectified direct-current voltage is extremely high, the semiconductor switch circuit 74 might be broken. Taking the problem into consideration, the breakdown voltage of the Zener diode ZDp is set lower than withstand voltages of the FETs 74a, 74b included in the semiconductor switch circuit 74. Therefore, even if the rectified direct-current voltage becomes higher, the FETs 74a, 74b can be prevented from being broken by the high voltage.

### Third Embodiment

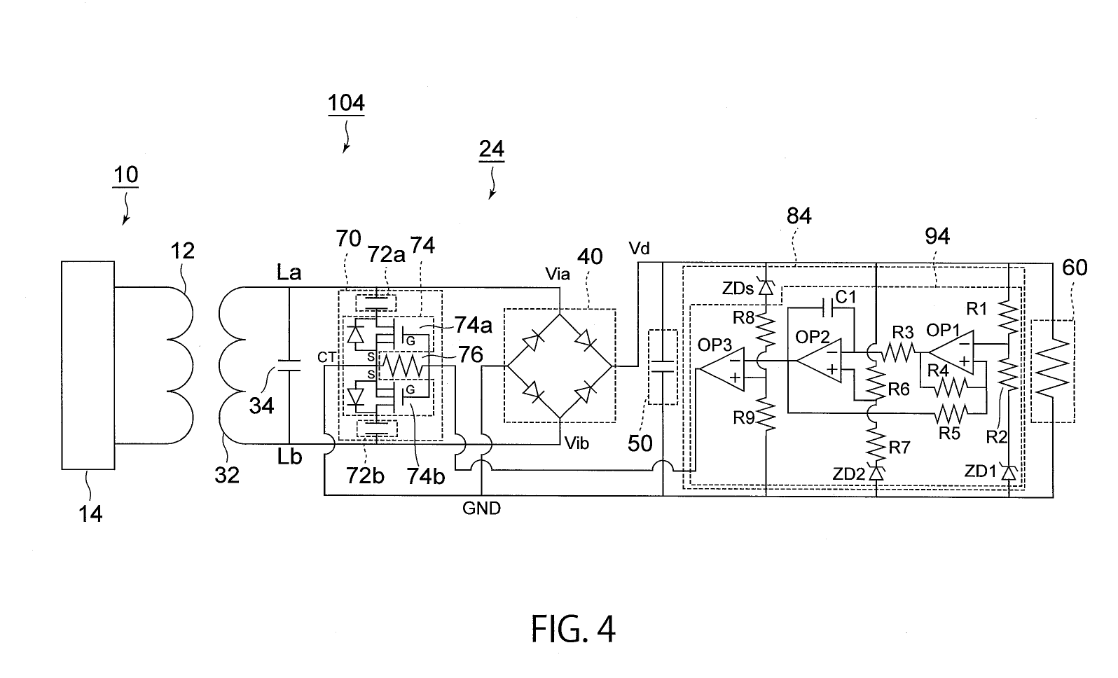

With reference to FIG. 4, a non-contact power transmission system 104 according to a third embodiment of the present invention has a structure similar to the non-contact power transmission system 100 according to the above-described first embodiment (see FIG. 1), except for a structure of a drive circuit 84 of a power-receiving device 24. Common components between FIG. 1 and FIG. 4 are depicted with reference numerals same as each other; explanation thereabout will be omitted. Thus, only the drive circuit 84 and distinct operations based thereon will be explained hereinafter.

The drive circuit 84 according to the present embodiment includes a drive voltage generation circuit 94, similar to the second embodiment. Although the drive voltage generation circuit 92 of the second embodiment supplies the substantially-constant voltage to the semiconductor switch circuit 74 of the frequency-changing circuit 70 upon the breakdown of the Zener diode ZDs, the drive voltage generation circuit 94 of the drive circuit 84 according to the present embodiment supplies pulses of voltage to the semiconductor switch circuit 74 of the frequency-changing circuit 70.

In detail, the drive voltage generation circuit 94 comprises three operational amplifiers OP1-OP3, nine resistors R1-R9, a capacitor C1 and two Zener diodes ZD1, ZD2.

The resistor R1 and the resistor R2 form a voltage divider circuit. The divided voltage thereby is supplied to the negative input terminal of the operational amplifier OP1. The Zener diode ZD1 is used to lift up the lower basis potential of the voltage divider circuit (R1+R2) from the ground, so that fluctuation of the divided value output from the voltage divider circuit (R1+R2) can be suppressed. Likewise, the resistor R6 and the resistor R7 form another voltage divider circuit. The divided voltage thereby is supplied to the positive input terminal of the operational amplifier OP2. The Zener diode ZD2 is used to lift up the lower basis potential of the voltage divider circuit (R6+R7) from the ground, so that fluctuation of the divided value output from the voltage divider circuit (R6+R7) can be suppressed, too.

The operational amplifier OP1, the resistor R3 and the resistor R4 form a

Schmidt circuit. The operational amplifier OP2, the resistor R5 and the capacitor C1 form an integrator circuit. Square waves output from the Schmidt circuit are integrated in the integrator circuit to be changed into triangle waves.

The operational amplifier OP3 is used as a comparator. When the Zener diode ZDs is broken down, the positive input terminal of the operational amplifier OP3 is supplied, as a reference voltage, with a voltage divided by the resistor R8 and the resistor R9. The operational amplifier OP3 compares the reference voltage with the triangle waves input into the negative input terminal of the operational amplifier OP3 so as to perform a PWM modulation with respect to the reference voltage to supply the semiconductor switch circuit 74 with pulse waves.

The above-explained structure performs pulse-driving of the semiconductor switch circuit 74 and can change the power-receiving frequency linearly.

### Fourth Embodiment

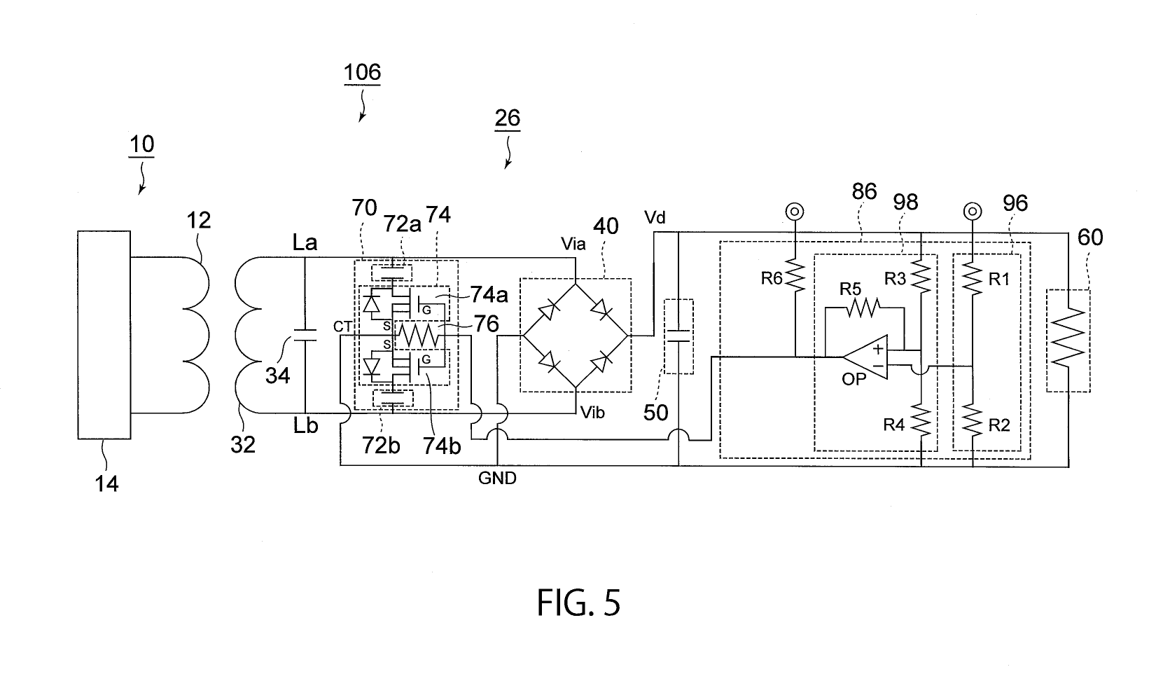

With reference to FIG. 5, a non-contact power transmission system 106 according to a fourth embodiment of the present invention has a structure similar to the non-contact power transmission system 100 according to the above-described first embodiment (see FIG. 1), except for a structure of a drive circuit 86 of a power-receiving device 26. Common components between FIG. 1 and FIG. 5 are depicted with reference numerals same as each other; explanation thereabout will be omitted. Thus, only the drive circuit 86 and distinct operations based thereon will be explained hereinafter.

The drive circuit 86 according to the present embodiment includes a reference voltage generation circuit 96 and a hysteresis comparator 98, wherein the reference voltage generation circuit 96 is for generating a reference voltage, and the hysteresis comparator 98 is for driving the semiconductor switch circuit 74 in response to the reference voltage and the rectified voltage.

In detail, the reference voltage generation circuit 96 comprises two resistors R1 and R2. The hysteresis comparator 98 comprises an operational amplifier OP and three resistors R3 to R5. As shown in FIG. 5, the resistor R1 and the resistor R2 form a voltage divider for dividing the power supply voltage. The divided power supply voltage is supplied, as a reference voltage, to the negative input terminal of the operational amplifier OP. The resistor R3 and the resistor R4 form a voltage divider for dividing the rectified voltage. The divided rectified-voltage is supplied to the positive input terminal of the operational amplifier OP. The operational amplifier OP according to the present embodiment is used to as a comparator. In other words, if the rectified voltage becomes higher than the reference voltage, the operational amplifier OP causes the semiconductor switch circuit 74 to turn on. Thus, the adjustment of the power-receiving frequency is performed to lower the reception voltage. Thereafter, when the rectified voltage becomes lower than the reference voltage at least by a certain voltage due to the performance of lowering the reception voltage, the operational amplifier OP causes the semiconductor switch circuit 74 to turn off. The certain voltage is determined by the resistor R5. Namely, the resistor R5 provides the operational amplifier OP with hysteresis. Thus, it can be prevented that the operational amplifier OP acts in response to a slight voltage difference such as noise.

Although the present invention is specifically explained hereinabove with reference to a plurality of embodiments, the present invention is not limited thereto.

For example, although each of the frequency-changing circuits 70 of the above-described embodiments has a single stage, multiple stages of the frequency-changing circuits 70 may be connected in parallel. In the connection, action timing of each frequency-changing circuit 70 may be shifted from others so that the control of the reception voltage is performed in multiple times.

Although the above-described frequency-changing circuit 70 comprises the FETs 74a, 74b, bipolar transistors may be used instead of the FETs 74a, 74b.

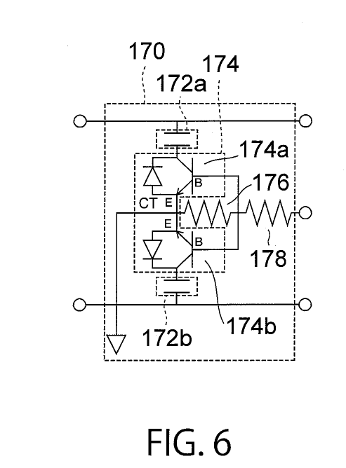

Specifically, as shown in FIG. 6, a frequency-changing circuit 170 comprises a first impedance 172a, a second impedance 172b, a semiconductor switch circuit 174, a resistor 176 and a current limitation resistor 178. Among them, the first impedance 172a, the second impedance 172b and the resistor 176 are same as the first impedance 72a, the second impedance 72b and the resistor 76, respectively.

The semiconductor switch circuit 174 has two npn-type bipolar transistors 174a, 174b. The base B of the bipolar transistor 174a and the base B of the bipolar transistor 174b are electrically connected to each other. The emitter E of the bipolar transistor 174a and the emitter E of the bipolar transistor 174b are electrically connected to each other, and a center tap CT is derived from the connection point therebetween. The bipolar transistors 174a, 174b have body diodes or parasitic diodes, respectively, and provide functions similar to the above-described FETs 74a, 74b. The current limitation resistor 178 is for limiting currents flowing into the bases B of the bipolar transistors 174a, 174b when the Zener diode ZDs is broken down.

The frequency-changing circuit 70 according to each of the aforementioned first to third embodiments may be replaced with the frequency-changing circuit 170 with the semiconductor switch circuit 174.

### Fifth Embodiment

Although the main purposes of the above-described embodiments are prevention of excessive reception voltages, embodiments of the present invention are not limited thereto. A fifth embodiment explained hereinbelow adjusts its circuit constant to output a predetermined constant voltage of the rectified voltage in each of the second embodiment to the fourth embodiment. Its circuit structure may be same as those of the second embodiment to the fourth embodiment (see FIGS. 3 to 5, respectively). After rectified, voltage smoothing may be carried out by the use of a diode and a smoothing capacitor.

The maximum value of the rectified voltage can be set by using the breakdown voltage of the Zener diode ZDs. Since each of the drive voltage generation circuits 92, 94 (see FIGS. 3, 4) has a hysteresis on a relation between its input and its output, the rectified voltage is kept in a certain voltage range.

If the rectified voltage becomes higher, the Zener diode ZDs is broken down, and the FETs 74a, 74b (see FIG. 3 and so on) turn on so that the impedance is shifted to lower the rectified voltage. If the rectified voltage becomes lower, the Zener breakdown is ended, and the FETs 74a, 74b turn off so that the impedance is shifted to heighten the rectified voltage. Based on these actions, the impedance is changed cyclically. The cycle keeps the rectified voltage in the certain voltage range.

The Zener diode ZDs is arranged after the rectification circuit 40 to detect the rectified voltage. The rectified voltage kept in the certain voltage range passes the diode and the smoothing capacitor so that voltage fluctuation is suppressed. Thus, more stable constant voltage can be output into the load 60 of the DC-DC converter, and so on.

The present structure can provide a stable constant voltage output so as to form a constant voltage output circuit. A voltage converter can be excluded from a system load of the DC-DC converter, and so on, independently of the weight of the load.

### Industrial Applicability

The present invention is applicable to a non-contact power transmission system for charging a secondary battery which is installed in a carryable or portable electronic device such as a cellular phone, an electric razor or a digital camera.

### Reference Signs List

10 power-transmitting device
12 power-transmitting antenna circuit
14 control section
20, 22, 24, 26 power-receiving device
32 power-receiving antenna circuit
La, Lb terminal
34 capacitor
40 rectification circuit (single-phase bridge rectification circuit)
Via, Vib input terminal
Vd rectification output terminal
GND ground terminal
50 smoothing circuit
60 load
70 frequency-changing circuit
72a first impedance (capacitor)
72b second impedance (capacitor)
74 semiconductor switch circuit
74a FET
74b FET
CT center tap
76 resistor
80, 82, 84, 86 drive circuit
ZDs Zener diode (for sensing variation)
92, 94 drive voltage generation circuit
96 reference voltage generation circuit
98 hysteresis comparator
ZDp, ZDc, ZD1, ZD2 Zener diode
R1˜R9 resistor
Tr1, Tr2transistor
OP, OP1˜OP3 operational amplifier
C1 capacitor
170 frequency-changing circuit
172a first impedance (capacitor)
172b second impedance (capacitor)
174 semiconductor switch circuit
174a bipolar transistor
174b bipolar transistor
176 resistor
178 current limitation resistor
100, 102, 104, 106 non-contact power transmission system

1. A power-receiving device comprising: a power-receiving antenna circuit for receiving power transmitted from a power-transmitting device in a non-contact power transmission system; a resonant capacitor; a rectification circuit for rectifying the power received at the power-receiving antenna circuit; a frequency-changing circuit for changing a power-receiving frequency of the power-receiving antenna circuit; and a drive circuit for driving the frequency-changing circuit, wherein:
the power-receiving antenna circuit has two terminals;
the resonant capacitor is coupled between the two terminals of the power-receiving antenna circuit;
the rectification circuit is a single-phase bridge rectification circuit and includes input terminals, a ground terminal and a rectification output terminal, the input terminals being connected to the two terminals of the power-receiving antenna circuit, respectively, the rectification output terminal being for outputting a rectified direct-current voltage;
the frequency-changing circuit includes a first impedance, a second impedance and a semiconductor switch circuit, one end of the first impedance being connected to one of the terminals of the power-receiving antenna circuit, one end of the second impedance being connected to a remaining one of the terminals of the power-receiving antenna circuit, the semiconductor switch circuit being connected between another end of the first impedance and another end of the second impedance;
the semiconductor switch circuit has a circuit structure that has a center tap as a circuit center and is symmetrical with respect to the center tap;
the center tap is coupled to the ground terminal of the rectification circuit; and
the drive circuit is coupled to the rectification output terminal and turns the semiconductor switch circuit on in response to the direct-current voltage.

2. The power-receiving device as recited in claim 1, wherein the first impedance and the second impedance are capacitors which have capacitances equal to one another.

3. The power-receiving device as recited in claim 1, wherein the drive circuit causes the semiconductor switch circuit to turn on when the direct-current voltage output from the rectification output terminal reaches a predetermined value.

4. The power-receiving device as recited in claim 3, wherein:
the drive circuit comprises a Zener diode for sensing variation of the direct-current voltage; and
the predetermined value is a breakdown voltage of the Zener diode.

5. The power-receiving device as recited in claim 4, wherein an anode of the Zener diode is coupled to the semiconductor switch circuit.

6. The power-receiving device as recited in claim 4, wherein the drive circuit further comprises a drive voltage generation circuit which is coupled between an anode of the Zener diode and the semiconductor switch circuit and, when the Zener diode is broken down, generates a drive voltage for driving the semiconductor switch circuit.

7. The power-receiving device as recited in claim 6, wherein the drive voltage generation circuit exhibits hysteresis on a relation between an input and an output thereof.

8. The power-receiving device as recited in claim 6, wherein the drive voltage generation circuit supplies the semiconductor switch circuit with pulses as the drive voltage when the Zener diode is broken down.

9. The power-receiving device as recited in claim 3, wherein the drive circuit comprises a reference voltage generation circuit for generating a reference voltage and a hysteresis comparator for driving the semiconductor switch circuit in response to the rectified direct-current voltage.

10. The power-receiving device as recited in claim 1, wherein:
the semiconductor switch circuit includes at least two Nch FETs;
gates of the two FETs are electrically connected with each other;
sources of the two FETs are connected with each other; and
the center tap is derived from a connection point between the sources.

11. The power-receiving device as recited in claim 1, wherein:
the semiconductor switch circuit includes at least two npn-type bipolar transistors;
bases of the two bipolar transistors are electrically connected with each other;
emitters of the two bipolar transistors are connected with each other; and
the center tap is derived from a connection point between the emitters.

12. A non-contact power transmission system comprising: the power-receiving device as recited in claim 1; and a power-transmitting device.
